(19) United States
(12) Patent Application Publication
(10) Pub. No.: US 2025/0190255 A1
(43) Pub. Date: Jun. 12, 2025

(54) SWAPPING FROM AN ACTIVE ADDRESS SPACE TO A SHADOW ADDRESS SPACE

(71) Applicant: INTERNATIONAL BUSINESS MACHINES CORPORATION, ARMONK, NY (US)

(72) Inventors: TABOR R. POWELSON, POUGHKEEPSIE, NY (US); EDWARD PRYOR, POUGHKEEPSIE, NY (US); RYAN THOMAS RAWLINS, NEW PALTZ, NY (US); ANDREW C. M. HICKS, HIGHLAND, NY (US); KRUNAL SHAH, FISHKILL, NY (US)

(21) Appl. No.: 18/534,922

(22) Filed: Dec. 11, 2023

(51) Int. Cl. G06F 9/50

(52) U.S. Cl. CPC G06F 9/5016

(57) ABSTRACT

Swapping from an active address space to a shadow address space may include: initializing, for an active address space, a shadow address space; receiving a request to swap from the active address space to the shadow address space; in response to the request, copying state information from the active address space to the shadow address space; and swap usage of the active address space to the shadow address space.

### BACKGROUND

The present disclosure relates to methods, apparatus, and products for swapping from an active address space to a shadow address space.

### SUMMARY

According to embodiments of the present disclosure, various methods, apparatus and products for swapping from an active address space to a shadow address space are described herein. In some aspects, swapping from an active address space to a shadow address space includes initializing, for an active address space, a shadow address space; receiving a request to swap from the active address space to the shadow address space; in response to the request, copying state information from the active address space to the shadow address space; and swap usage of the active address space to the shadow address space. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a diagram of an example computing environment for swapping from an active address space to a shadow address space in accordance with some embodiments of the present disclosure.

FIG. 2 sets forth a flowchart of an example method for swapping from an active address space to a shadow address space in accordance with some embodiments of the present disclosure.

FIG. 3 sets forth another flowchart of an example method for swapping from an active address space to a shadow address space in accordance with some embodiments of the present disclosure.

FIG. 4 sets forth another flowchart of an example method for swapping from an active address space to a shadow address space in accordance with some embodiments of the present disclosure.

FIG. 5 sets forth another flowchart of an example method for swapping from an active address space to a shadow address space in accordance with some embodiments of the present disclosure.

FIG. 6 sets forth another flowchart of an example method for swapping from an active address space to a shadow address space in accordance with some embodiments of the present disclosure.

FIG. 7 sets forth another flowchart of an example method for swapping from an active address space to a shadow address space in accordance with some embodiments of the present disclosure.

FIG. 8 sets forth another flowchart of an example method for swapping from an active address space to a shadow address space in accordance with some embodiments of the present disclosure.

### DETAILED DESCRIPTION

In some operating systems, each running job is allocated its own address space. The address space for a given job is an allocated range of virtual memory addresses that the job may address (e.g., reference) when performing its operations. When a fix or enhancement is applied to the software executing a particular job, the job may need to be restarted to make these fixes or enhancements effective. This may require that the address space for that job be restarted (e.g., reallocated). During this restart period the job will be unavailable. Accordingly, jobs that provide services such as disaster recovery or continuous availability of storage devices will not provide their protection during the restart period.

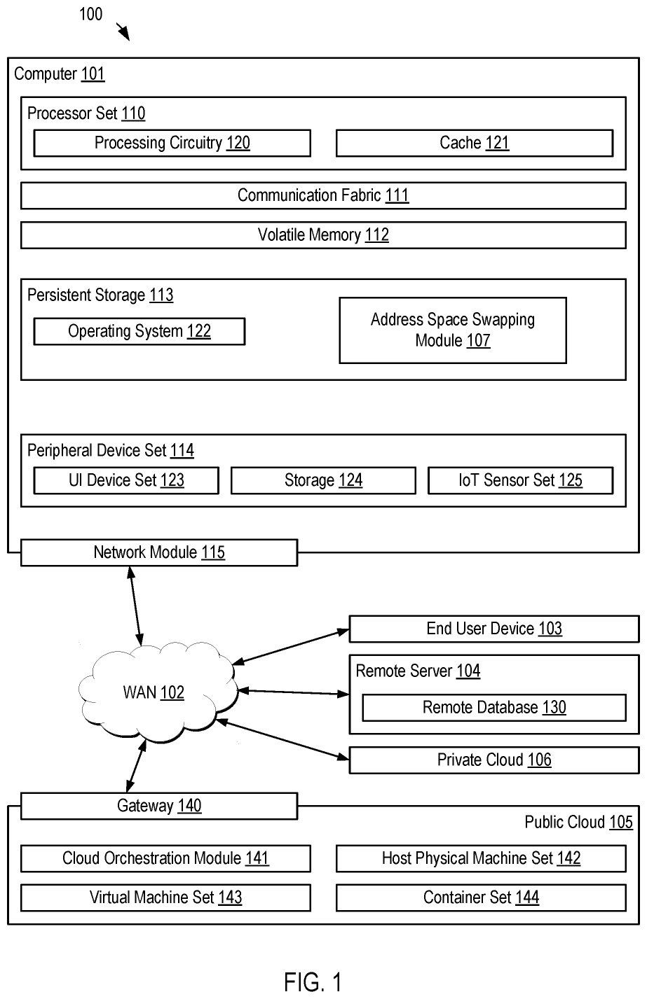

With reference now to FIG. 1, shown is an example computing environment according to aspects of the present disclosure. Computing environment 100 contains an example of an environment for the execution of at least some of the computer code involved in performing the various methods described herein, such as address space swapping module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

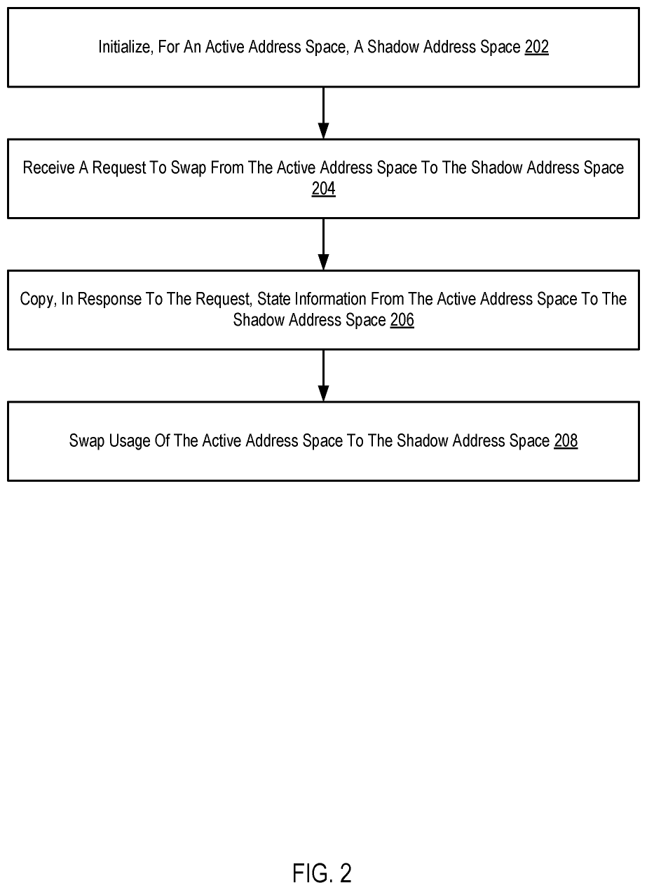

FIG. 2 sets forth a flowchart of an example method of swapping from an active address space to a shadow address space in accordance with some embodiments of the present disclosure. The method of FIG. 2 includes initializing 202, for an active address space, a shadow address space. The active address space is an address space for a currently executing job. Accordingly, the active address space may be addressed or referenced by that job during its execution. A shadow address space is another address space allocated for the same job as the active address space. The shadow address space may not be addressed or referenced during execution of the job so long as the active address space remains active. After swapping from the active address space to the shadow address space, described in further detail below, the job may then reference the shadow address space (e.g., the formerly designated shadow address space now serving as an active address space). Put differently, input and output resources are maintained for the active address space until a command or signal to switch to the shadow address space.

In some embodiments, initializing 202 the shadow address space may be performed in response to initializing the corresponding job and active address space. For example, in response to a job beginning execution and having allocated an active address space, a shadow address space may be initialized for that job. In some embodiments, initializing 202 the shadow address space may be performed in response to some event, such as detecting a modification or update to the corresponding job. In some embodiments, initializing 202 the shadow address space may be performed for a particular subset or classification of job, such as jobs that jobs facilitate continuous protection or uptime of some resources.

In some embodiments, initializing 202 the shadow address space includes allocating a range of virtual memory addresses for the shadow address space. In some embodiments, the range of virtual memory addresses for the shadow address space may include a portion of private storage only accessible by the job corresponding to the shadow address space. In some embodiments, the range of virtual memory addresses for the shadow address space may include a portion of common storage accessible to other jobs in addition to the job corresponding to the shadow address space.

In some embodiments, initializing 202 the shadow address space includes initializing a task structure for the shadow address space. A task structure for an address space (e.g., shadow or active) includes one or more tasks, threads, and the like (e.g., sets of executable instructions) to perform particular operations of a given job. In some embodiments, initializing the task structure for the shadow address spaces includes attaching these tasks to the shadow address space without making work available for these tasks. Thus, the tasks for the shadow address space are waiting for work without initially performing any productive operations. In contrast, the tasks for the active address space may be running and processing any work made available to them.

After initializing 202 the shadow address space, the active address space continues to serve the operations of the corresponding job. System events that may affect the shadow address space (e.g., by virtue of being directed to the corresponding job or affecting many address spaces) will be filtered from the shadow address space.

The method of FIG. 2 also includes receiving 204 a request to swap from the active address space to the shadow address space. Swapping from the active address space to the shadow address space causes the shadow address space to be used by the corresponding job instead of the active address space, effectively redesignating the shadow address space as an active address space. In some embodiments, the request to swap from the active address space to the shadow address space may be generated in response to a user command or input, such as a user command to swap from the active address space to the shadow address space. In some embodiments, the request to swap from the active address space to the shadow address space may be generated by some process, service, or application executed on the system. For example, a process, service, or application may apply a fix, enhancement, or other modification to the job corresponding to the active address space and may request swapping to the shadow address space such that this modification can take effect.

The method of FIG. 2 also includes copying 206, in response to the request, state information from the active address space to the shadow address space. State information includes data stored in the active address space used by the corresponding job. In other words, the state information includes data reflecting a state of processing or activity by the corresponding job. Once swapping from the active address space to the shadow address space has been completed, this allows the shadow address space to store the necessary information to resume the functionality of the corresponding job. As an example, for a job that maintains continuous availability of monitored storage devices, the state information for that job may include configuration data of monitored devices, such as listings of primary and secondary devices, names of particular configurations, policy information, and the like. One skilled in the art will appreciate that the state information for a particular active address space will vary depending on the particular job associated with that active address space.

In some embodiments, copying 206 the state information from the active address space to the shadow address space may include serializing the state information in the active address space. As described herein, serializing the state information assumes control of the state information during the copying process, effectively locking or otherwise restricting modification of the state information during the copying process. For example, a logical latch, lock, and the like may be implemented to prevent modification of the state information during the copying process. This ensures a consistent view of the state information when swapping from the active address space to the shadow address space.

The method of FIG. 2 also includes swapping 208 usage from the active address space to the shadow address space. Swapping 208 usage from the active address space to the shadow address space causes the corresponding job to use the shadow address space instead of the active address space. Accordingly, the shadow address space now becomes the active address space for the corresponding job. In some embodiments, swapping usage from the active address space to the shadow address space includes swapping input/output (I/O) resources from the active address space to the shadow address space. Thus, jobs (e.g., either the particular job corresponding to the active and shadow address spaces or other jobs) attempting to read data from or write data to the address space of the particular job will cause data to be read from or written to the shadow address space instead of the active address space. For example, in some embodiments, swapping I/O resources from the active address space to the shadow address space may include removing the active address space from logical grouping of resources accessible to multiple systems and adding the shadow address space to this logical grouping of resources. As another example, as will be described in further detail below, swapping I/O resources from the active address space to the shadow address space may include updating a data structure that associates jobs (e.g., programs) with address spaces to associate the particular job with the shadow address space instead of the active address space.

After swapping 208 usage from the active address space to the shadow address space, the shadow address space now serves as the active address space for the corresponding job. In some embodiments, in response to the shadow address space becoming the active address space, another shadow address space may be initialized for the corresponding job as described above. Thus, a shadow and active address space may be maintained for a given job after swapping a previously designated shadow address space to an active address space. In some embodiments, the original formerly active address space remains active and may become the shadow for the now active address space. Keeping the formerly active address space active to become the new shadow address space may allow a subsequent swap back to the new shadow/formerly active address space, which for example may be used for testing the address space swap functionality or for recovering to the original state of the address spaces.

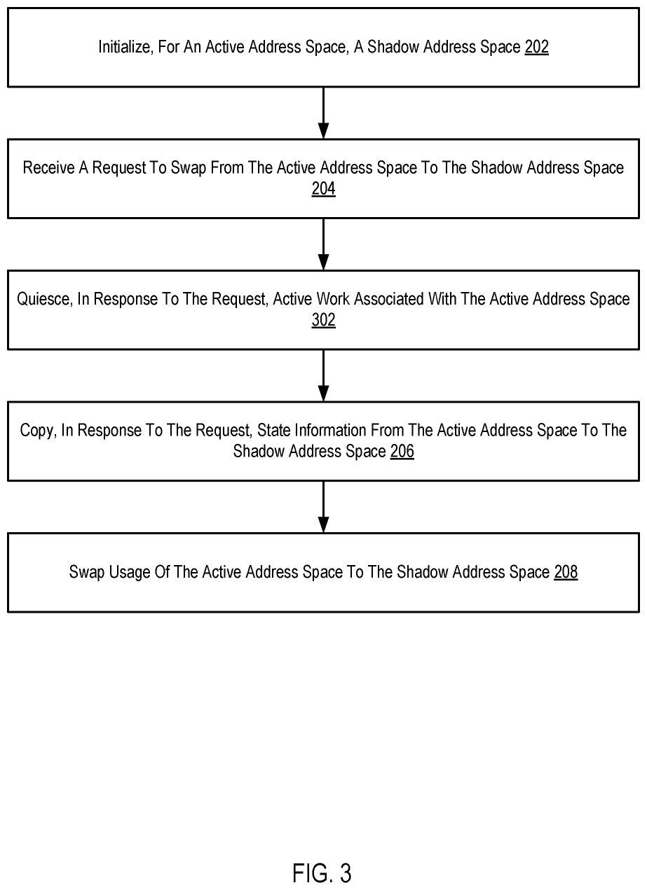

For further explanation, FIG. 3 sets forth a flowchart of an example method of swapping from an active address space to a shadow address space in accordance with some embodiments of the present disclosure. The method of FIG. 3 is similar to FIG. 2 in that the method of FIG. 3 also includes: initializing 202, for an active address space, a shadow address space; receiving 204 a request to swap from the active address space to the shadow address space; copying 206, in response to the request, state information from the active address space to the shadow address space; and swapping 208 usage of the active address space to the shadow address space.

The method of FIG. 3 differs from FIG. 2 in that the method of FIG. 3 also includes quiescing 302, in response to the request, active work associated with the active address space. In some embodiments, quiescing 302 active work associated with the active address space includes servicing any pending read operations, write operations, or combinations thereof directed to the active address space. In some embodiments, quiescing 302 active work associated with the active address space includes restricting issuance of new operations directed to the active address space until swapping 208 usage from the active address space to the shadow address space is completed. Quiescing 302 active work associated with the active address space ensures that the copied 206 state information reflects all work active when the request to swap from the active address space to the shadow address space was received 204.

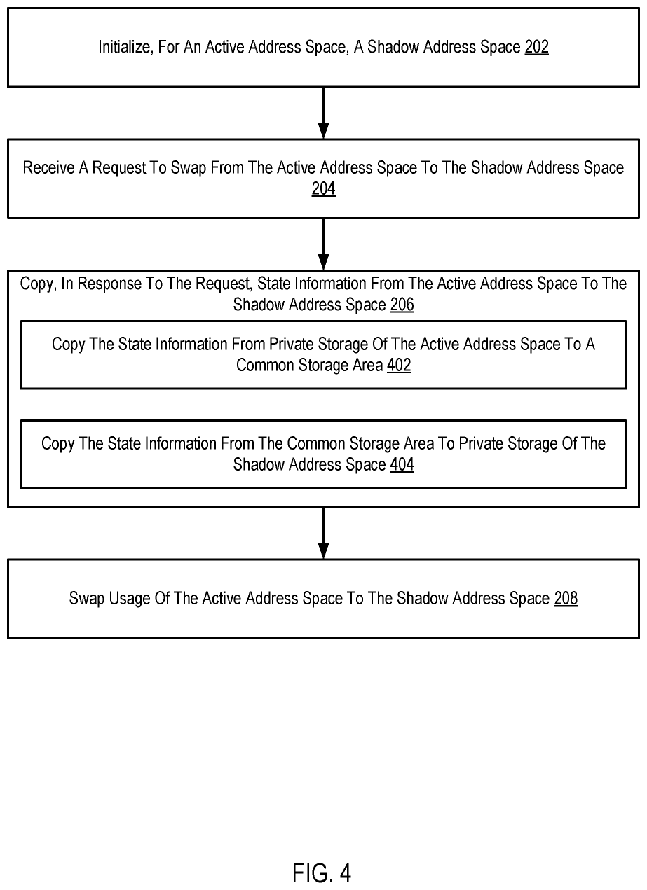

For further explanation, FIG. 4 sets forth a flowchart of an example method of swapping from an active address space to a shadow address space in accordance with some embodiments of the present disclosure. The method of FIG. 4 is similar to FIG. 2 in that the method of FIG. 4 also includes: initializing 202, for an active address space, a shadow address space; receiving 204 a request to swap from the active address space to the shadow address space; copying 206, in response to the request, state information from the active address space to the shadow address space; and swapping 208 usage of the active address space to the shadow address space.

The method of FIG. 4 differs from FIG. 2 in that copying 206, in response to the request, state information from the active address space to the shadow address space further comprises copying 402 the state information from private storage of the active address space to a common storage area. As is set forth above, a given address space may include a portion of private storage accessible only to the job corresponding to the given address space. Accordingly, the job may store and update the state information in the private storage of the active address space during execution. In response to the request, this state information may be copied to a common storage area (e.g., a memory area other than the private storage). In some embodiments, the common storage area may include a common storage portion of the active address space. In some embodiments, the common storage area may include a common storage of another address space.

The method of FIG. 4 further differs from FIG. 2 in that copying 206, in response to the request, state information from the active address space to the shadow address space further comprises copying 404 the state information from the common storage area to private storage of the shadow address space. As the corresponding job will access the state information in private storage of the shadow address space after switching, this places the state information in the correct area of the shadow address space.

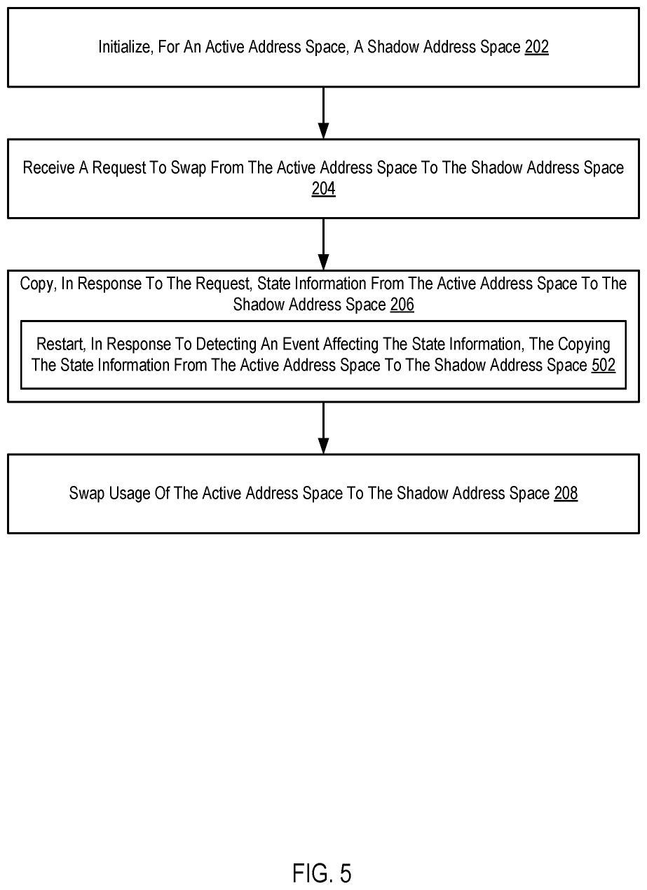

For further explanation, FIG. 5 sets forth a flowchart of an example method of swapping from an active address space to a shadow address space in accordance with some embodiments of the present disclosure. The method of FIG. 5 is similar to FIG. 2 in that the method of FIG. 5 also includes: initializing 202, for an active address space, a shadow address space; receiving 204 a request to swap from the active address space to the shadow address space; copying 206, in response to the request, state information from the active address space to the shadow address space; and swapping 208 usage of the active address space to the shadow address space.

The method of FIG. 5 differs from FIG. 2 in that copying 206, in response to the request, state information from the active address space to the shadow address space further comprises restarting 502, in response to detecting an event affecting the state information, the copying the state information from the active address space to the shadow address space. The event affecting the state information is some event detected by the system that would cause the state information to be modified. For example, where the job corresponding to the active address space monitors devices, a detected change to a device configuration may require that the state information to be modified.

In some embodiments, the event may be detected during the copying 206 of the state information. In some embodiments, the event may be detected after copying 206 of the state information but prior to swapping 208 usage from the active address space to the shadow address space. For example, in some embodiments, after copying 206 the state information, the state information may be serialized so as to assume control and prevent modification of the state information. It may then be determined if any event that affects the state information occurred during the copying 206 that would affect the state information. If an event did occur, serialization may be released for the state information. Once no events affecting the state information are in progress, copying 206 of the state information may be restarted 502 such that the most recent version of the state information is copied from the active address space to the shadow address space.

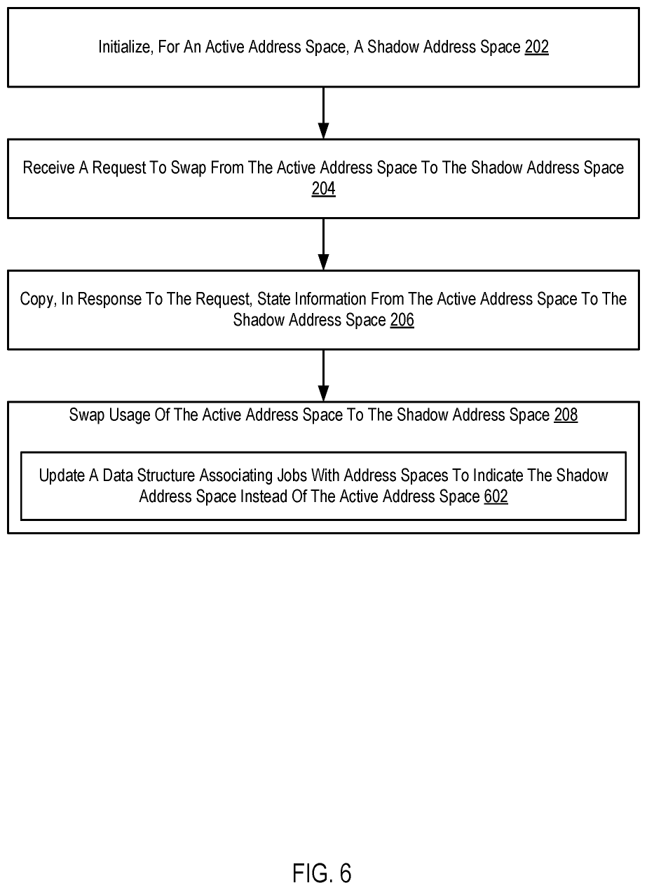

For further explanation, FIG. 6 sets forth a flowchart of an example method of swapping from an active address space to a shadow address space in accordance with some embodiments of the present disclosure. The method of FIG. 6 is similar to FIG. 2 in that the method of FIG. 6 also includes: initializing 202, for an active address space, a shadow address space; receiving 204 a request to swap from the active address space to the shadow address space; copying 206, in response to the request, state information from the active address space to the shadow address space; and swapping 208 usage of the active address space to the shadow address space.

The method of FIG. 6 differs from FIG. 2 in that swapping 208 usage of the active address space to the shadow address space includes updating 602 a data structure associating jobs with address spaces to indicate the shadow address space instead of the active address space. As is set forth above, swapping 208 usage of the active address space to the shadow address space may include swapping I/O resources from the active address space to the shadow address space such that I/O operations accessing the address space of the corresponding job are directed to the shadow address space. In some embodiments, a job may access the address space of another job based on a known entry point (e.g., a known start address) of the address space of the other job. For example, the address space of the other job may be accessed using the known entry point and some offset.

Accordingly, in some embodiments, a data structure may be maintained that associates particular jobs with the entry points of their respective address spaces. Prior to updating 602, the data structure may associate the entry point of the active address space with the corresponding job. Updating 602 the data structure causes the data structure to instead associate the corresponding job with the entry point of the shadow address space. Thus, another job wishing to access the address space of the corresponding job will access the data structure to receive the entry point of the shadow address space.

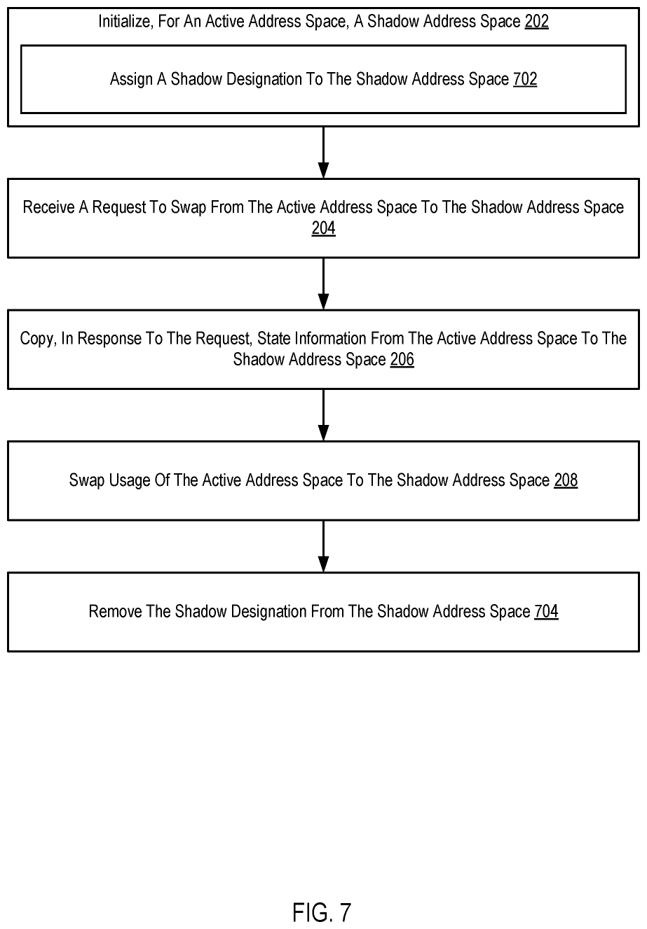

For further explanation, FIG. 7 sets forth a flowchart of an example method of swapping from an active address space to a shadow address space in accordance with some embodiments of the present disclosure. The method of FIG. 7 is similar to FIG. 2 in that the method of FIG. 7 also includes: initializing 202, for an active address space, a shadow address space; receiving 204 a request to swap from the active address space to the shadow address space; copying 206, in response to the request, state information from the active address space to the shadow address space; and swapping 208 usage of the active address space to the shadow address space.

The method of FIG. 7 differs from FIG. 2 in that initializing 202, for an active address space, a shadow address space includes assigning 702 a shadow designation to the shadow address space. The shadow designation is a flag or other data that indicates that the shadow address space is a shadow address space (e.g., not an active address space). This designation may be used, for example, for filtering events by the shadow address space. This designation may also be used when determining if a shadow address space has already been created for a given job, preventing the creation of multiple concurrent shadow address spaces for the given job.

The method of FIG. 7 differs from FIG. 2 in that the method of FIG. 7 also includes removing 704 the shadow designation from the shadow address space. After swapping 208 usage of the active address space to the shadow address space, the previously designated shadow address space now serves as the active address space for its corresponding job. Accordingly, its shadow designation is removed 704 as it is now an active address space. This may allow for other shadow address spaces to be created for the corresponding job as no current address space for the corresponding job has a shadow designation.

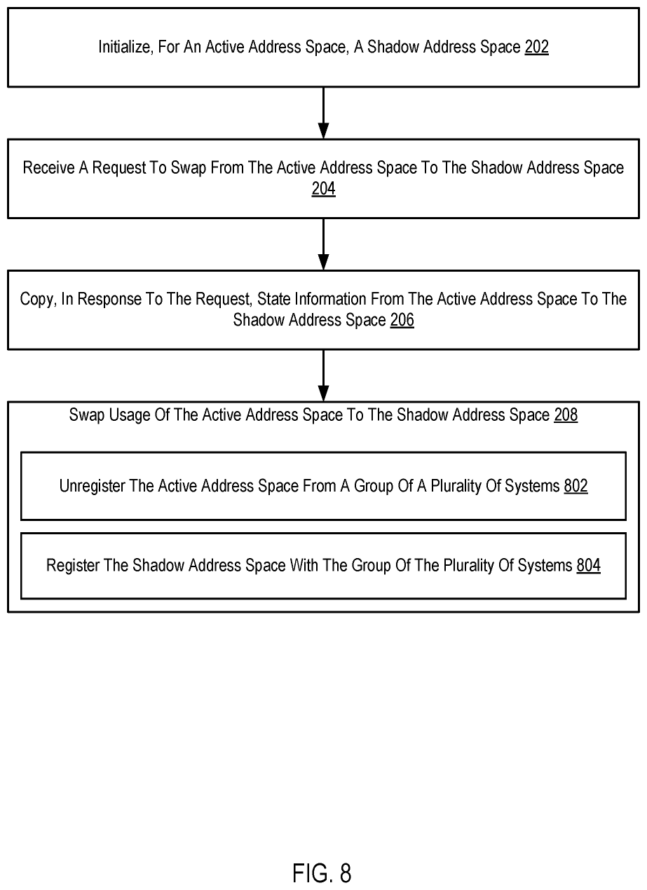

For further explanation, FIG. 8 sets forth a flowchart of an example method of swapping from an active address space to a shadow address space in accordance with some embodiments of the present disclosure. The method of FIG. 8 is similar to FIG. 2 in that the method of FIG. 8 also includes: initializing 202, for an active address space, a shadow address space; receiving 204 a request to swap from the active address space to the shadow address space; copying 206, in response to the request, state information from the active address space to the shadow address space; and swapping 208 usage of the active address space to the shadow address space.

The method of FIG. 8 differs from FIG. 2 in that swapping 208 usage of the active address space to the shadow address space includes unregistering 802 the active address space from a group of a plurality of systems; registering 804 the shadow address space with the group of the plurality of systems. In some embodiments, multiple systems may cooperate using some amount of shared resources to perform work. In such embodiments, these systems communicate with each other using signals, messages, and the like, as well as access each others respective common portions of address spaces. To facilitate this inter-system communication or operation, a logical grouping of systems may be maintained to which various the various systems may join. This logical grouping may register the active address spaces of the respective systems to allow inter-system access of these address spaces.

Accordingly, as the shadow address space will serve as the active address space after swapping 208 occurs, the active address space should be unregistered 802 from this group of the plurality of systems. The shadow address space will then be registered 804 with the group of the plurality of systems such that, once it serves as the active address space, the other systems will be able to access or communicate with the formerly shadow, now active address space.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
initializing, for an active address space, a shadow address space;
receiving a request to swap from the active address space to the shadow address space;
in response to the request, copying state information from the active address space to the shadow address space; and
swapping usage of the active address space to the shadow address space.

2. The method of claim 1, further comprising quiescing, in response to the request, active work associated with the active address space.

3. The method of claim 1, wherein copying the state information from the active address space to the shadow address space comprises:
copying the state information from private storage of the active address space to a common storage area; and
copying the state information from the common storage area to private storage of the shadow address space.

4. The method of claim 1, wherein copying the state information from the active address space to the shadow address space comprises restarting, in response to detecting an event affecting the state information, the copying the state information from the active address space to the shadow address space.

5. The method of claim 1, wherein swapping I/O resources from the active address space to the shadow address space comprises updating a data structure associating jobs with address spaces to indicate the shadow address space instead of the active address space.

6. The method of claim 1, wherein swapping I/O resources from the active address space to the shadow address space comprises:
unregistering the active address space from a group of a plurality of systems; and
registering the shadow address space with the group of the plurality of systems.

7. The method of claim 1, wherein initializing the shadow address space comprises assigning a shadow designation to the shadow address space, and wherein the method further comprises removing the shadow designation from the shadow address space.

8. An apparatus comprising:
a processing device; and
memory operatively coupled to the processing device, wherein the memory stores computer program instructions that, when executed, cause the processing device to:
initialize, for an active address space, a shadow address space;
receive a request to swap from the active address space to the shadow address space;
in response to the request, copy state information from the active address space to the shadow address space; and
swap usage of the active address space to the shadow address space.

9. The apparatus of claim 8, wherein the computer program instructions, when executed, further cause the processing device to quiesce, in response to the request, active work associated with the active address space.

10. The apparatus of claim 8, wherein copying the state information from the active address space to the shadow address space comprises:
copying the state information from private storage of the active address space to a common storage area; and
copying the state information from the common storage area to private storage of the shadow address space.

11. The apparatus of claim 8, wherein copying the state information from the active address space to the shadow address space comprises restarting, in response to detecting an event affecting the state information, the copying the state information from the active address space to the shadow address space.

12. The apparatus of claim 8, wherein swapping I/O resources from the active address space to the shadow address space comprises updating a data structure associating jobs with address spaces to indicate the shadow address space instead of the active address space.

13. The apparatus of claim 8, wherein swapping I/O resources from the active address space to the shadow address space comprises:
unregistering the active address space from a group of a plurality of systems; and
registering the shadow address space with the group of the plurality of systems.

14. The apparatus of claim 8, wherein initializing the shadow address space comprises assigning a shadow designation to the shadow address space, and wherein the computer program instructions, when executed, further cause the processing device to remove the shadow designation from the shadow address space.

15. A computer program product comprising a computer readable storage medium, wherein the computer readable storage medium comprises computer program instructions that, when executed:
initialize, for an active address space, a shadow address space;
receive a request to swap from the active address space to the shadow address space;
in response to the request, copy state information from the active address space to the shadow address space; and
swap usage of the active address space to the shadow address space.

16. The computer program product of claim 15, wherein the computer program instructions, when executed, quiesce, in response to the request, active work associated with the active address space.

17. The computer program product of claim 15, wherein copying the state information from the active address space to the shadow address space comprises:
copying the state information from private storage of the active address space to a common storage area; and
copying the state information from the common storage area to private storage of the shadow address space.

18. The computer program product of claim 15, wherein copying the state information from the active address space to the shadow address space comprises restarting, in response to detecting an event affecting the state information, the copying the state information from the active address space to the shadow address space.

19. The computer program product of claim 15, wherein swapping I/O resources from the active address space to the shadow address space comprises updating a data structure associating jobs with address spaces to indicate the shadow address space instead of the active address space.

20. The computer program product of claim 15, wherein swapping I/O resources from the active address space to the shadow address space comprises:
unregistering the active address space from a group of a plurality of systems; and
registering the shadow address space with the group of the plurality of systems.
